(19) United States
(12) Patent Application Publication
(10) Pub. No.: US 2008/0209991 A1
(43) Pub. Date: Sep. 4, 2008

(54) FUEL TANK DEVICE CAPABLE OF DETECTING CONSISTENCY

(76) Inventors: TSANG-MING CHANG, Taipei (TW); Chien-An Chen, Kaohsiung (TW); Wen Jui Chuang, Kaohsiung (TW)

Correspondence Address: G. LINK CO., LTD., 3550 BELL ROAD, MINOOKA, IL, 60447, US

(21) Appl. No.: 11/838,691

(22) Filed: Aug. 14, 2007

(30) Foreign Application Priority Data
Aug. 15, 2006 (CN) 200620123175.2

(51) Int. Cl. G01M 15/04

(52) U.S. Cl. 73/114.42

(57) ABSTRACT

A fuel tank device capable of detecting consistency includes a fuel storage tank and a consistency detecting box. The fuel storage tank provides fuel needed by a fuel cell as a fuel supply source for the fuel cell. A consistency detecting passage is disposed near the bottom of the fuel storage tank for the fuel flowing outward to the consistency detecting box. The consistency detecting box further includes a signal emitting component, which is disposed in the consistency detecting box and capable of emitting a signal piercing the fuel in the consistency detecting box, a signal receiving component, which is disposed in the consistency detecting box and capable of collecting the signal after piercing the fuel in the consistency detecting box and a consistency detecting component, which is attached to the consistency detecting box, compares the emitted signal with the collected signal for detecting a consistency of the fuel.

### BACKGROUND OF THE INVENTION

1. Field of the Invention

The present invention is related to a fuel tank and particularly to a fuel tank device capable of detecting consistency.

2. Brief Description of the Related Art

The fuel cell is a power generation device by means of chemical energy converting to electrical energy. Comparing to the traditional power generation. The fuel cell provides advantages such as low contamination, low noise, high energy intensity and higher energy converting rate. Therefore, the fuel cell is a power source with potential of developmental. Due to the preceding advantages, the applications of the fuel cell cover a wide range of fields including the portable electronic device, the household power generation, the transportation tool and the aerospace industry.

Different types of fuel cells each provide an operational principle with a little difference from each other. Taking the direct methanol fuel cell as an example, when the methanol solution performs reaction of oxidization at the anode accelerant layer, hydrogen ions, electrons and carbon oxides can be produced. The hydrogen ions are transmitted to the cathode by means of electrolyte. The electrons are transmitted to the load to work via the external electric circuit and then are sent to the cathode. Meanwhile, oxygen, which is supplied to the cathode, performs deoxidization at the cathode accelerant layer with the hydrogen ions and the electrons to produce water.

However, the direct methanol in the fuel cell is easy to permeate the hydrogen ions and the proton exchange membrane (PEM) and, as a result, the voltage of the fuel cell and the fuel cell efficiency become lower. Especially, it is worse in case of the methanol fuel with high consistency being employed. In order to avoid the preceding deficiency of permeation, the methanol fuel with low consistency is adopted instead of the methanol fuel with high consistency in spite of the methanol fuel with high consistency being capable of reducing size of the fuel cell.

Mostly, the methanol fuel with lower consistency are obtained by means of the methanol fuel with higher consistency being diluted such that in order to know well the consistency of the methanol at the time of the fuel flowing into the fuel cell, a device for detecting consistency of the methanol is essential.

Currently, the device for detecting consistency of the methanol is arranged in a pipeline between the fuel cell and the fuel mixing tank. Although the arrangement is easy to set up, the device for detecting consistency of the methanol has to provide features of high sensitivity and short response time. However, it is much more expensive to provide a device with features of high sensitivity and short response time and the integral cost of the fuel cell is increased substantially.

### SUMMARY OF THE INVENTION

An object of the present invention is to provide a fuel tank capable of detecting consistency with which fuel is guided to a consistency detecting box from a fuel storage tank and consistency of the fuel is detected with consistency detecting device in the consistency detecting box.

In order to achieve the preceding object, a fuel tank device capable of detecting consistency according to the present invention includes a fuel storage tank and a consistency detecting box. The fuel storage tank provides fuel needed by a fuel cell as a fuel supply source. A consistency detecting passage is disposed near the bottom of the fuel storage tank for the fuel flowing outward to the consistency detecting box. The consistency detecting box further includes a signal emitting component, which is disposed in the consistency detecting box and capable of emitting a signal piercing the fuel in the consistency detecting box, a signal receiving component, which is disposed in the consistency detecting box and capable of collecting the signal after piercing the fuel in the consistency detecting box and a consistency detecting component, which is attached to the consistency detecting box, compares the emitted signal with the collected signal for detecting a consistency of the fuel.

### BRIEF DESCRIPTION OF THE DRAWINGS

The detail structure, the applied principle, the function and the effectiveness of the present invention can be more fully understood with reference to the following description and accompanying drawings, in which:

FIG. 1A is a perspective view of a fuel tank device capable of detecting consistency according to the present invention;

FIG. 1B is a sectional view of the fuel tank device shown in FIG. 1A.

FIG. 2 is a block diagram illustrating parts in a consistency box of the fuel tank device according to the present invention; and

FIG. 3 is a block diagram illustrating fuel storage tanks associated with a fuel mixing tank according to present invention.

### DETAILED DESCRIPTION OF THE INVENTION

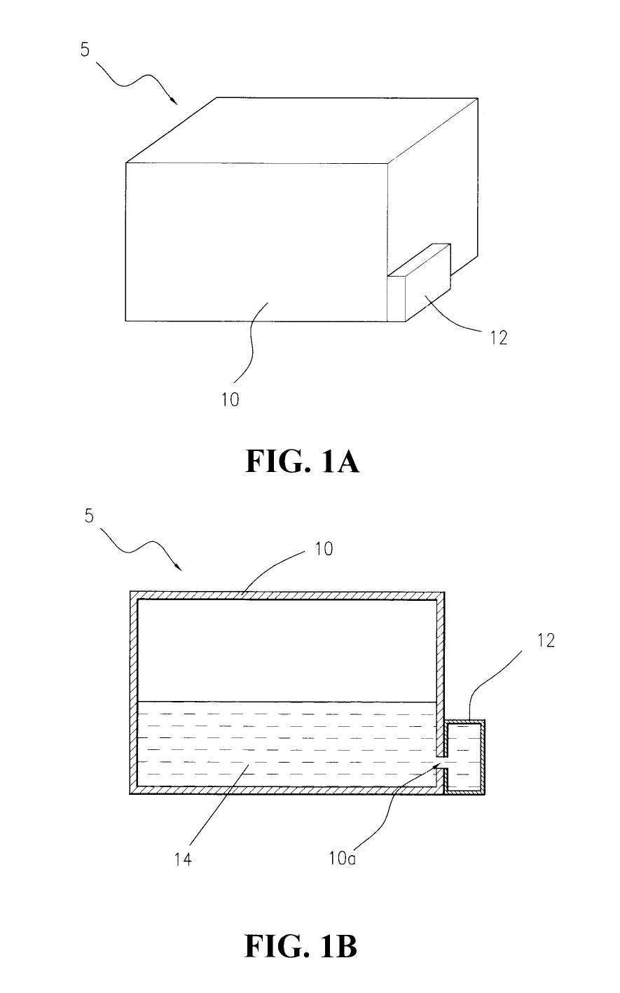

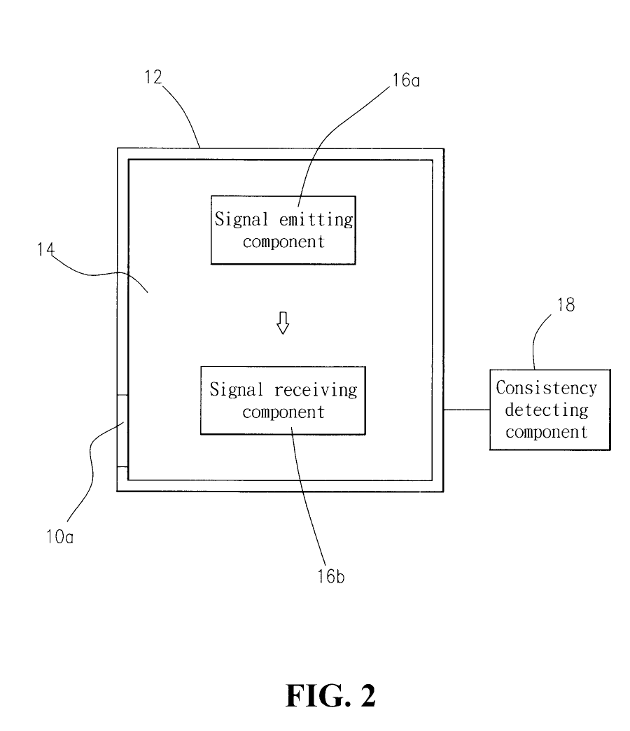

Referring to FIGS. 1A and 1B, a fuel tank device capable of detecting consistency according to the present invention is illustrated. It can be seen in FIG. 1A that a fuel tank device 5, which is capable of detecting consistency in addition to a fuel supply source for the fuel cell, includes a fuel storage tank 10 and a consistency detecting box 12. It can be seen in FIG. 1B that a consistency detecting passage 10a is disposed between the fuel storage tank 10 and the consistency detecting box 12 so that fuel 14 in the fuel storage tank 10 can flow into the consistency detecting box 12 via the consistency detecting passage 10a for being detected with a consistency detecting device shown in FIG. 2. The consistency detecting box 12 has a size much less than the fuel storage tank 10. In practice, the consistency detecting box 12 provides a height 30 mm only.

No strict restriction with regard to provision and shape is applied to the consistency detecting passage 10a. But, it is preferable that the consistency detecting passage 10a is disposed at a position as closer to the bottom of the fuel storage tank 10 as possible under a condition that the fuel 14 keeps moving into the consistency detecting box 12 even if less amount of the fuel 14 is left in the fuel storage tank 10.

Referring to FIG. 2, the consistency detecting box 12 is illustrated to include a signal emitting component 16a, a signal receiving component 16b and a consistency detecting component 18. The signal emitting component 16a and the signal receiving component 16b are disposed in the consistency detecting box 12. The consistency detecting component 18 can be disposed either inside or outside the consistency detecting box 12.

Once the signal emitting component 16a is actuated to emit a signal, the signal pierces the fuel 14 in the consistency detecting box 12 and is collected by the signal receiving component 16b. The consistency detecting component 18 detects the consistency of the fuel 14 by means of comparing the signal from the signal emitting component to the signal collected by the signal receiving component 16b.

For instance, the signal emitting component 16a is a part capable of emitting ultraviolet and the signal receiving component 16b is a corresponding part capable of collecting the ultraviolet. According to Beer-Lambert principle, the consistency of the fuel 14 is proportional to light absorbance of the fuel 14. Hence, the consistency detecting component 18 is capable of figuring out the consistency of the fuel 14 based on the light absorbance.

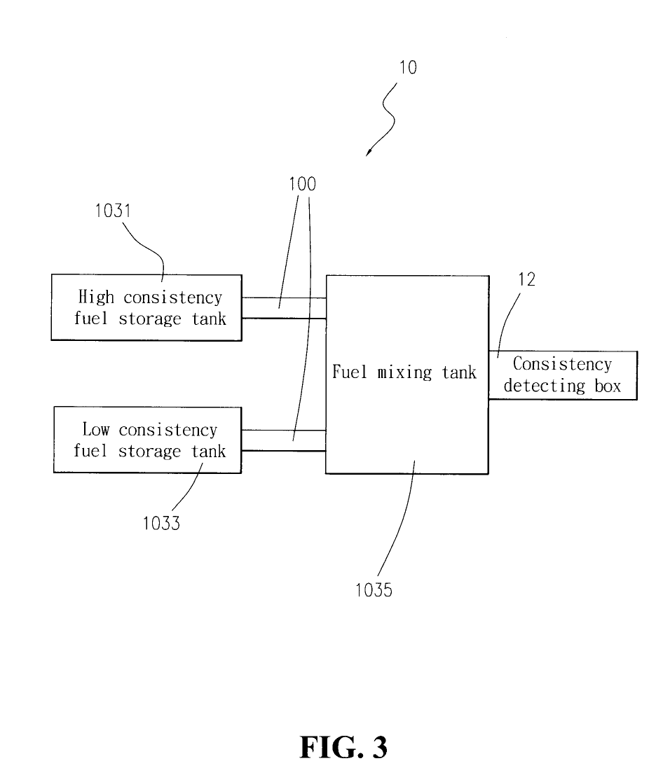

Referring to FIG. 3, the fuel storage tank is illustrated to further include a high consistency fuel storage tank 1031, a low consistency fuel storage tank 1033 and a fuel mixing tank 1035. A pipeline 100 is provided for the fuel mixing tank 1035 to communicate with the high consistency fuel storage tank 1031 and the low consistency fuel storage tank 1033 respectively. The same consistency detecting passage is disposed between the fuel mixing tank 1035 and the consistency detecting box 12 as well for guiding the fuel into the consistency detecting box 12 such that the consistency detecting device performs function of consistency detection as the preceding description.

The signal emitting component 16a, the signal receiving component 16b and the consistency detecting component 18 can be employed with the conventional parts to implement the present invention. The characteristics of the present invention are in that the signal emitting component 16a, the signal receiving component 16b and the consistency detecting component 18 are configured to fabricate the fuel tank device 5 of the present invention, which is capable of detecting consistency.

It is appreciated that the fuel tank device capable of detecting consistency according to the present invention allows the fuel 14 in the fuel storage tank 10 to be guided to the consistency detecting box 12 directly and the consistency detecting device in the consistency detecting box 12 is capable of detecting the consistency of the fuel. Therefore, low fabrication cost is needed for the fuel tank device capable of detecting consistency according to the present invention.

While the invention has been described with referencing to preferred embodiments thereof, it is to be understood that modifications or variations may be easily made without departing from the spirit of this invention, which is defined by the appended claims.

What is claimed is:

1. A fuel tank device capable of detecting consistency comprising:
a fuel storage tank providing fuel needed by a fuel cell and having a consistency detecting passage near the bottom thereof for the fuel flowing outward; and
a consistency detecting box connecting with the consistency detecting passage and receiving the fuel flowing outward from said fuel storage tank;
wherein said consistency detecting box further comprises:
a signal emitting component being disposed in said consistency detecting box and capable of emitting a signal piercing said fuel in said consistency detecting box;
a signal receiving component being disposed in said consistency detecting box corresponding to said signal emitting component and capable of collecting said signal after piercing said fuel in said consistency detecting box; and
a consistency detecting component being attached to said consistency detecting box to compare said signal emitted by said signal emitting component with said signal collected by said signal receiving component such that a consistency of said fuel is capable of being detected.

2. The fuel tank device capable of detecting consistency as defined in claim 1, wherein said consistency detecting box has a height of 30 mm.

3. The fuel tank device capable of detecting consistency as defined in claim 1, wherein said fuel storage tank further includes a high consistency fuel storage tank, a low consistency fuel storage tank and a fuel mixing tank.
